(19) United States
(12) Patent Application Publication
(10) Pub. No.: US 2019/0295023 A1
(43) Pub. Date: Sep. 26, 2019

(54) SYSTEM, METHOD, AND COMPUTER PROGRAM PRODUCT FOR PREDICTING THE VALUE OF AN IDEA BASED ON CROWD INPUT

(71) Applicants: James Gardner, Oakland, CA (US); Anna Gordon, San Francisco, CA (US); Andrew Guinther, Louisville, CO (US); Manas Hardas, Union CIty, CA (US)

(72) Inventors: James Gardner, Oakland, CA (US); Anna Gordon, San Francisco, CA (US); Andrew Guinther, Louisville, CO (US); Manas Hardas, Union CIty, CA (US)

(73) Assignee: Spigit, Inc., San Francisco, CA (US)

(21) Appl. No.: 16/384,906

(22) Filed: Apr. 15, 2019

Related U.S. Application Data
(63) Continuation of application No. 14/808,780, filed on Jul. 24, 2015.
(60) Provisional application No. 62/059,479, filed on Oct. 3, 2014.

(51) Int. Cl. G06Q 10/06; G06F 17/18

(52) U.S. Cl. CPC G06Q 10/06375; G06F 17/18

(57) ABSTRACT

The disclosure is directed to a system, method, and computer program for predicting the value of an idea based on crowd input. Users are prompted to vote as to whether variables for an idea (e.g., cost, time to implement, revenue/cost-savings) are greater than or less than proposed values. The proposed values are derived from probability distributions for the variables. Each time a vote is received for a variable, a new probability distribution for the variable is created, wherein parameters of the distribution (e.g., mean, shape parameter) are based on the vote data. The polling continues for each of the variables until a poll termination event occurs. The mean of the final probability distribution for each variable represents the system's estimate (or prediction) of the crowd's consensus value for the variable. Ideas are ranked based on the final consensus value estimates for the ideas.

### RELATED APPLICATIONS

This application is a continuation application of U.S. patent application Ser. No. 14/808,780, which claims the benefit of U.S. Provisional Application No. 62/059,479, filed on Oct. 3, 2014 entitled “System, Method, and Computer Program for Predicting the Value of an Idea based on Crowd Input,” the contents of which are incorporated by reference as if fully disclosed herein.

### BACKGROUND OF THE INVENTION

### 1. Field of the Invention

This invention relates generally to idea management systems and, more particularly, to predicting the value of an idea based on crowd input.

### 2. Description of the Background Art

Many enterprises have platforms via which employees can submit ideas for future projects, cost-savings, etc. While current solutions enable users to indicate whether or not they like an idea, they do not quantify the cost of implementing the idea, the time to implement the idea, and the revenue or cost-savings generated by the idea. Quantifying the amount of potential future profit associated with new business ideas can help with idea selection, assist in financial forecasting, encourage responsible decision making, and calculating the ROI of idea management tools. Therefore, there is a need for estimating the time, cost, and revenue or cost-savings associated with an idea in order to determine the monetary value of an idea in a community's idea-management platform.

### SUMMARY OF THE DISCLOSURE

The present disclosure is directed to a system, method, and computer program product for predicting the value of an idea based on crowd input. An idea management system provides a user interface in which users vote as to whether variables for an idea (e.g., cost, time, revenue/cost-savings) are greater than or less than proposed values. Based on the votes, the system calculates a consensus value for each variable. The final consensus value for each variable is the system's estimate of the crowd's estimate of the value of the variable. In one embodiment, the system ranks idea based on the consensus values for the idea.

In certain embodiments, to implement the foregoing, the system creates a probability distribution for values for each of: (i) a cost to implement an idea, (ii) a time to implement the idea, and (iii) a revenue/savings associated with the idea, wherein each probability distribution initially has a mean value that is predetermined.

In such embodiments, the system polls a plurality of users as to cost, time, and revenue/saving values for the idea. Specifically, the system displays a proposed value for a cost, time, or revenue/savings variable for the idea and prompts the user to vote whether the user's estimate for the variable is greater than or less than the proposed value. The proposed values for the variables displayed to users are derived from the respective probability distributions for the variables.

In response to receiving a vote for a value of one of the variables, the system creates a new probability distribution for the variable. Creating a new probability distribution including calculating a new mean and a new shape parameter for the probability distribution based on votes received for the variable, wherein calculating a new mean comprises calculating a consensus value for the variable that reflects vote(s) received for the variable and using the consensus value as the new mean. In certain embodiments, creating a new shape parameter comprises: (1) calculating an agreement score that reflects a degree to which users agree on the consensus value, (2) calculating a standard deviation of votes that disagree with the consensus value, and (3) calculating a new shape parameter for the probability distribution as a function of the agreement score and the standard deviation of votes that disagree with the consensus value.

The polling continues until a poll termination event occurs. In certain embodiments, a poll termination event is the expiration of a time period for polling. In other embodiments, the poll termination event is the receipt of a minimum number of votes for each of the variables. In yet other embodiments, the system determines whether (i) the agreement score for each variables reaches a threshold value (i.e., indicates that the crowd has honed in on a consensus value), or (ii) a minimum number of votes for each of the variables has been received or the time limit for the polling has expired. In certain embodiments, when a poll termination event occurs, the system calculates a ranking for the idea based on the last-calculated consensus values for the cost, time, and revenue/savings variables. The system displays a ranked list of ideas in a user interface based on the calculated rankings.

In certain embodiments, a consensus value is calculated using a weighted average of up and down votes.

In certain embodiments, the agreement score is based on a ratio of (i) the number of votes pointing towards the consensus value to (ii) the total number of votes received for the variable.

In certain embodiments, the probability distribution is a log-normal distribution. In certain embodiments, the rank for an idea is a metric of (Revenue-Cost)/Time, using the last-calculated consensus values for the revenue/saving, cost, and time variables and factoring in the agreement scores for the revenue/saving, cost, and time variables.

### BRIEF DESCRIPTION OF THE DRAWINGS

FIG. 1 is a flowchart that illustrates a method, according to one embodiment of the disclosure, for predicting the value of an idea based on crowd input.

FIG. 2 is a flowchart that illustrates an example implementation of the method of FIG. 1.

FIG. 3 is a graph that illustrates an example log-normal distribution.

FIG. 4 is a screen shot that illustrates an example user interface according to one embodiment of the disclosure.

FIG. 5 is a flowchart that illustrates a method for creating a new probability distribution according to one embodiment of the disclosure.

FIG. 6 is a chart that illustrates an example of a consensus value calculation.

FIG. 7 is a screen shot that illustrates an example user interface for a ranked list of ideas.

FIG. 8 is a graph that illustrates an example progression of a log-normal distribution as polling progresses.

FIG. 9 is a block diagram that illustrates an example idea management system according to one embodiment of the disclosure.

### DETAILED DESCRIPTION OF THE PREFERRED EMBODIMENTS

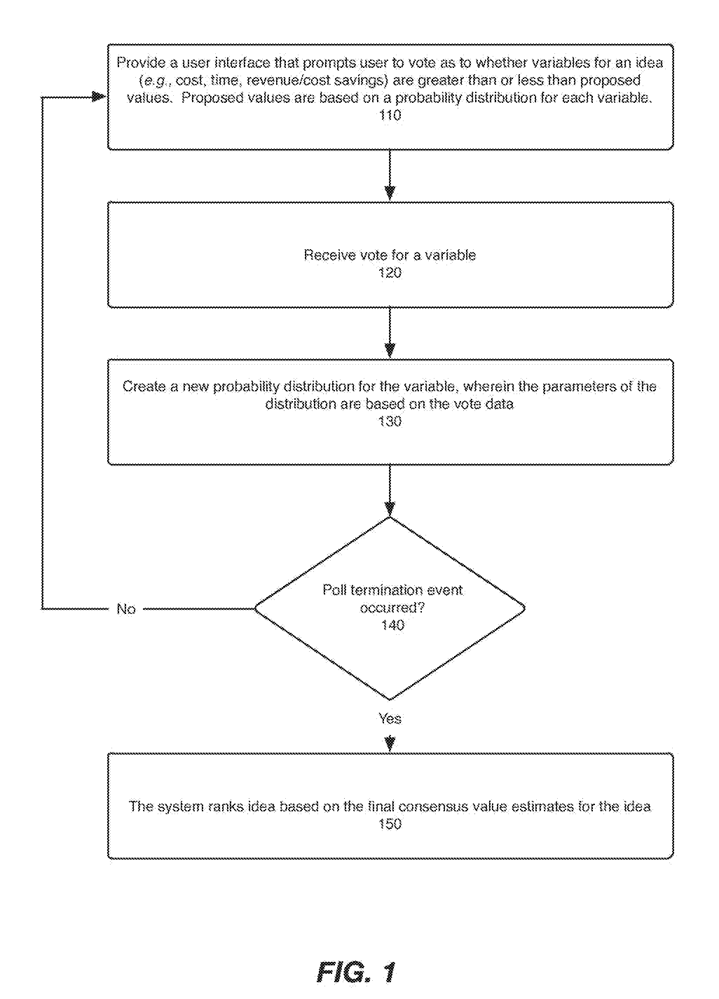

FIG. 1 illustrates a method, according to one embodiment, for predicting the value of an idea based on crowd input. The method is performed by an idea management system comprising one or more computer devices. The idea management system (“the system”) provides a user interface that prompts users to vote as to whether variables for an idea (e.g., cost, time, revenue/cost-savings) are greater than or less than proposed values (step 110). The proposed values are derived from probability distributions for the variables. Each time a vote is received for a variable (step 120), the system creates a new probability distribution for the variable, wherein parameters of the distribution (e.g., mean, shape parameter) are based on the vote data (step 130). The polling continues for each of the variables until a poll termination event occurs (e.g., a time limit expires, minimum number of votes received, etc.) (step 140). The mean of the final probability distribution for each variable represents the system's estimate (or prediction) of the crowd's consensus value for the variable. In one embodiment, the system ranks the idea based on the final consensus value estimates for the idea (step 150). The ranking represents the system's prediction of the relative value of the idea as compared to other ideas in the system.

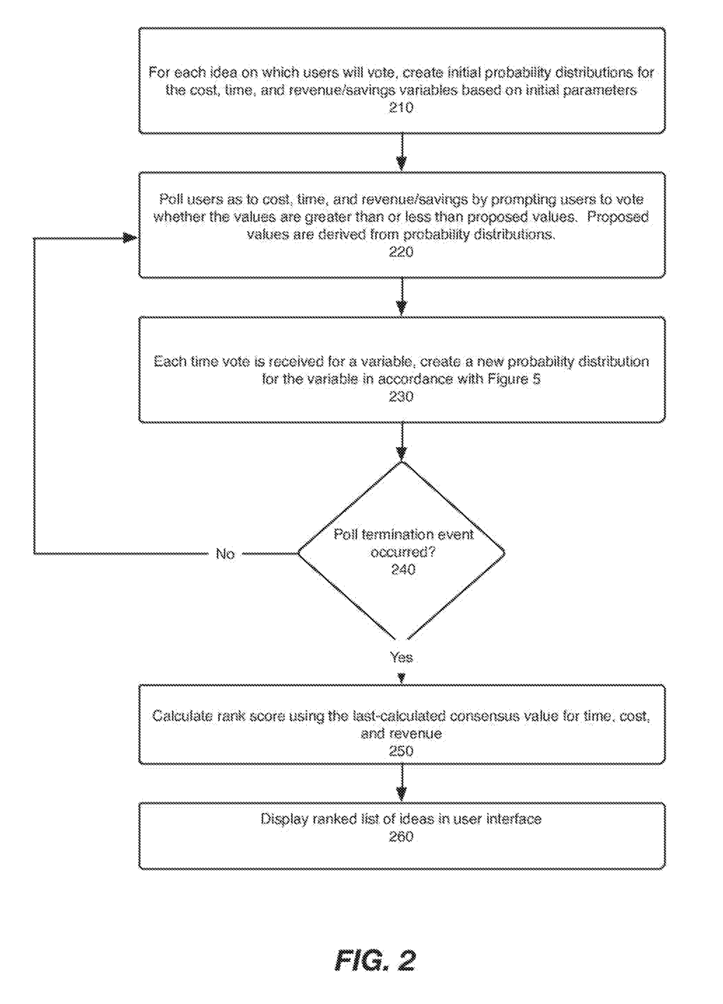

FIG. 2 illustrates an embodiment of the foregoing method in which users vote on the cost to implement an idea, the amount time required to implement the idea, and the amount of revenue/saving associated with the idea. For each idea on which users will vote, the system creates an initial probability distribution for values for each of the following variables: (i) a cost to implement an idea, (ii) a time to implement the idea, and (iii) a revenue/savings associated with the idea, wherein each probability distribution initially has a mean value and a shape parameter that is predetermined (step 210). As discussed below, the values on which users vote are derived from the probability distributions, and the mean and shape parameter for a distribution are recalculated as each applicable vote is received.

In one embodiment, a log-normal distribution is used for each variable because it takes values from 0 to ∞ (i.e., no negative values), but those skilled in the art will appreciate that other probability distributions may be used. A log-normal distribution has the property of positive skewness, meaning the mass of the distribution is concentrated on the left, and it has a long right tail. This leaves the possibility for the crowd's estimate to get very large on occasion, an event with low probability.

The probability distribution has two parameters: (1) a mean (represented by the mu symbol, μ, in the equations herein), and (2) the shape parameter (represented by sigma symbol, σ, in the equations herein). For each idea, the system starts with predetermined, initial values for each of these parameters. For example, in one embodiment, for each idea, the following initial means are used for the initial revenue, cost, and time distributions:
μᵣₑᵥ=$400,000
μ_{cost}=$300,000
μₜᵢₘₑ=120 days

In one embodiment, the initial shape parameter for each probability distribution is σ=0.75. This provides a nice spread: not too wide or too small. As described below, the mean and shape parameter are shifted when up and down votes are received for displayed values. If there is consensus by the crowd on the value of a variable, the distribution is designed to shift toward that value, then shrink around it, providing a consensus value with high certainty.

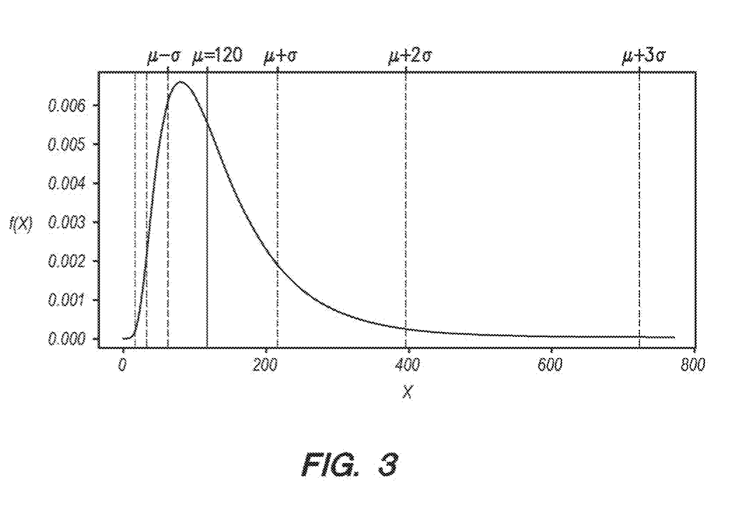

FIG. 3 illustrates an example of a log normal distribution for the time variable in which μₜᵢₘₑ=120 days and σ=0.5.

Referring again to FIG. 2, the system polls a plurality of users as to cost, time, and revenue/saving values for an idea (step 220). Specifically, the system displays proposed values for a cost, time, and revenue/savings variables for the idea and prompts the user to vote whether the user's estimate for each variable is greater than or less than the proposed value. The proposed values for the variables displayed to users are randomly derived from the respective probability distributions for the variables.

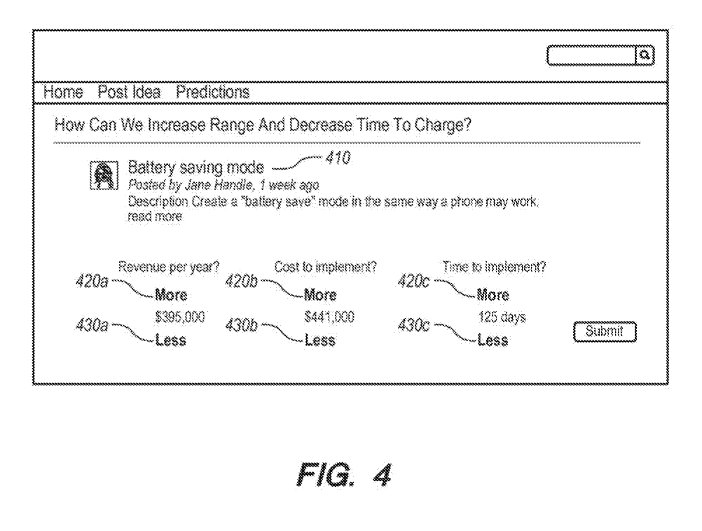

FIG. 4 illustrates an example user interface generated by the system for polling users. In this example, a user is asked to vote on the idea “Battery saving mode” 410 for the challenge “How Can We Increase Range and Decrease Time To Charge?”. Specifically, the user is prompted to vote whether the annual revenue generated by the idea is more or less than $395,000, whether the cost to implement the idea is more or less than $441,00, and whether the time to implement the idea is more or less than 125 days. The user can vote by selecting the “more” or “less” button (420a-c, 430a-c) for each question. A user may be prompted to vote for all variables (as illustrated in FIG. 4) or just one or two of the variables.

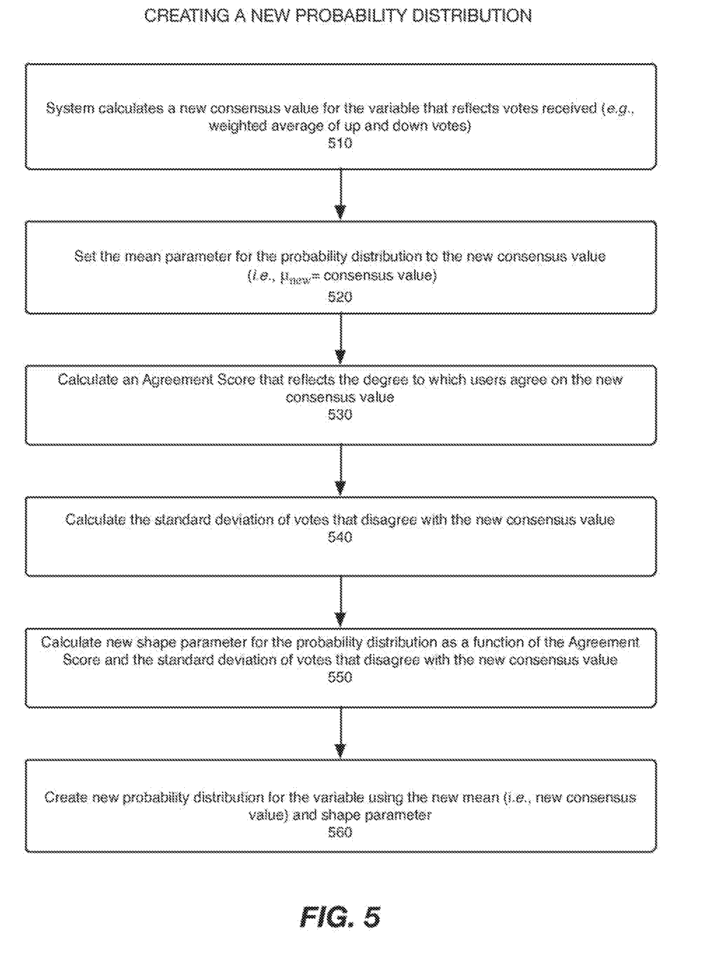

Each time the system receives a vote for a value of one of the variables, the system creates a new probability distribution for the variable (step 230). FIG. 5 illustrates the steps for creating a new probability distribution in this embodiment. The system calculates a new consensus value for the variable that reflects vote(s) received for the variable (step 510), and uses the consensus value as the new mean for the new probability distribution (i.e., μ_{new}=consensus value) (step 520).

In one embodiment, the consensus value is calculated using a weighted average of up and down votes. For example, the consensus value may be calculated as follows:
(a) Let U=set of up votes and D=the set of down votes.
(b) Calculate the weighted average of the 75th percentile of the up votes, denoted U₇₅, and the 25th percentile of the down votes, D₂₅, as shown in the formula below:

$${Consensus\_value}_{new} = \frac{{U}_{75} * count ( U ) + {D}_{25} * count ( D )}{count ( U ) + count ( D )}$$

[symbol]

where count(U) is the total number of up votes and count(D) is the total number of down votes.

The 75^{th} percentile of up votes is the value receiving an up vote below which lie exactly 75% of the other values given up votes. Likewise, the 25^{th} percentile of down votes is the value receiving a down vote below which are 25% of the other values given down votes. For example, if every number between 0-99 is given an up vote, U₇₅=75. Those skilled in the art will appreciate that different percentiles may be used for the weighted up and down votes.

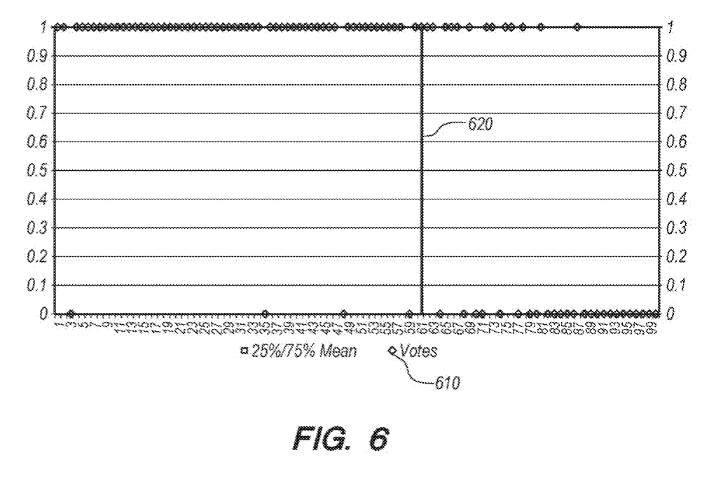

FIG. 6 is a chart that illustrates what a consensus value calculation using the above formula looks like. In the illustrated chart, the diamonds 610 represent a user's vote on a displayed value (the number on the x-axis), where y=1 corresponds to up votes and y=0 corresponds to down votes. The vertical line 620 shows where the new consensus value will fall given the up and down votes on the randomly generated values, and calculated with the 25/75 percentile method. One can see that there is some overlap in votes and some outliers, but the new consensus value still falls in a place that makes sense, with a majority of people agreeing.

When users are first able to vote on a question, the displayed values and votes are likely to be highly volatile. Later in the voting process, one can expect the evidence of the crowd's opinion to yield increasingly steady results, but initially the value will depend only on a few users' votes. To account for this in calculating the consensus value and the Agreement Score (see below), the system, in one embodiment, adds a weight of x number of votes (e.g., 20 votes) agreeing on the initial mean in the initial distribution, and decrements x by one as each new vote comes in. Once the system receives x votes from the crowd, the weight completely disappears. The weight keeps the initial consensus values from being unrealistically volatile, but does not affect the numbers so much that they stay stagnant.

As stated above, the new mean in the distribution is set to the new consensus value (step 520), as represented below:

μ_{new}=Consensus_value_{new}

After calculating the new consensus value (μ_{new}), the system calculates an Agreement Score (AS) that reflects a degree to which users agree on the new consensus value (step 530). The system uses an algorithm that takes into consideration the consistency of the votes from the crowd. In one embodiment, the Agreement Score is based on a ratio of (i) the number of votes pointing towards the consensus value to (ii) the total number of votes received for the variable. For example, for the i^{th} received vote, the Agreement Score may be calculated as follows:

$$AS ( {μ}_{new} ) = {( 1 - {( \frac{4}{5} )}^{i} )}^{2} * \frac{count ( votes pointing toward {μ}_{new} )}{total number votes} .$$

The first part of the formula, (1−(4/5)ⁱ)², weighs down the agreement score when there are very few votes, but does not affect the score when there are many votes. This is also designed to reduce volatility in the early rounds of voting. Different weights may be used in other embodiments.

With the above formula, the closer the agreement score is to 1, the more the crowd agrees on the consensus value. A low agreement score (e.g., less than 0.5) indicates that there is disagreement on the value of the variables. This can be valuable information as well, as a final low Agreement Score may indicate that there is a lot of risk associated with pursuing the idea.

The system also calculates the standard deviation of votes that disagree with the new consensus value (μ_{new}) (step 540). For example, the standard deviation may be calculated as follows:

$${σ}_{d} = \sqrt{\frac{{\sum }_{i} {( ln ( {μ}_{new} ) - ln ( {X}_{i} ) )}^{2}}{count ( disagreeing votes )} ,}$$

where Xᵢ is the i^{th} value displayed to a user who voted away from μ_{new}.

The system calculates a new shape parameter for the probability distribution as a function of the Agreement Score and the standard deviation of votes that disagree with the consensus value (i.e., (μ_{new})(step 550)). For example, the shape parameter (σ) may be calculated as follows:

$$σ = \sqrt{\frac{{σ}_{d}^{2} + {( 1 - AS ( {μ}_{new} ) )}^{2}}{2}}$$

The higher the Agreement Score, the smaller the shape parameter, as a high Agreement Score indicates that the system is honing in on the crowd's estimate. Also, the smaller the standard deviation of votes that disagree with the consensus value, the smaller the shape parameter. In other words, the value of the shape parameter decreases as user votes converge toward agreement on the consensus value for the variable, and the probability distribution shrinks around the consensus value.

Once the new mean and shape parameter are calculated, the system creates a new probability distribution for the applicable variable (step 560).

Returning again to FIG. 2, after creating the new probability distribution, the system determines if a poll termination event has occurred (step 240). In one embodiment, the poll termination event is the expiration of a time limit for the polling. In another embodiment, a poll termination event is the receipt of a minimum number of votes for each of the variables of an idea. In yet another embodiment, the poll termination event is the earlier of the Agreement Score satisfying a threshold and either the expiration of a time limit or the receipt of a minimum number of votes for each of the variables.

If a poll termination event has not occurred, the system repeats steps 220 and 230. Otherwise, the system uses the last-calculated consensus values for time, cost, and revenue/savings to rank the idea (step 250). In one embodiment, the system calculates a rank score as a metric of (Revenue-Cost)/Time, multiplied by the respective Agreement

Scores. For example, the following algorithm may be used:

$$Rank Score = \frac{1 + {μ}_{rev} * {AS}_{rev} - {μ}_{cost} * ( 2 - {AS}_{cost} )}{1 + {μ}_{time} * ( 2 - {AS}_{time} )} .$$

In the above formula, μᵣₑᵥ, μ_{cost}, and μₜᵢₘₑ are the final consensus values calculated for the revenue/savings, cost, and time variables. The final consensus values are the system's estimate of the crowd's consensus on the values of the variables. ASᵣₑᵥ, AS_{cost}, and ASₜᵢₘₑ are the final Agreement Scores calculated for the revenue/savings, cost, and time variables.

The rank score represents the system's prediction of the relative value of the idea.

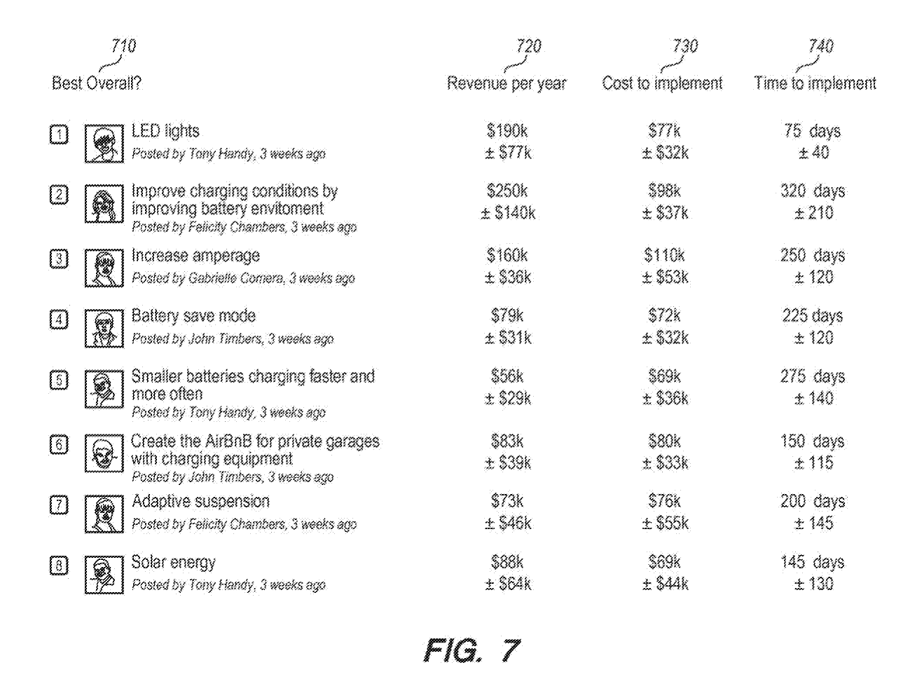

For ideas for which polling is complete, the system displays the ideas in a ranked list (step 260). The ideas are listed in descending order of their rank score. FIG. 7 illustrates an example user interface that displays a ranked list of ideas. In column 710, ideas are listed by title in descending order of rank (i.e., highest ranked first). In columns 720, 730, and 740, the last-calculated consensus values for the revenue/savings, cost, and time are respectively displayed for each listed idea.

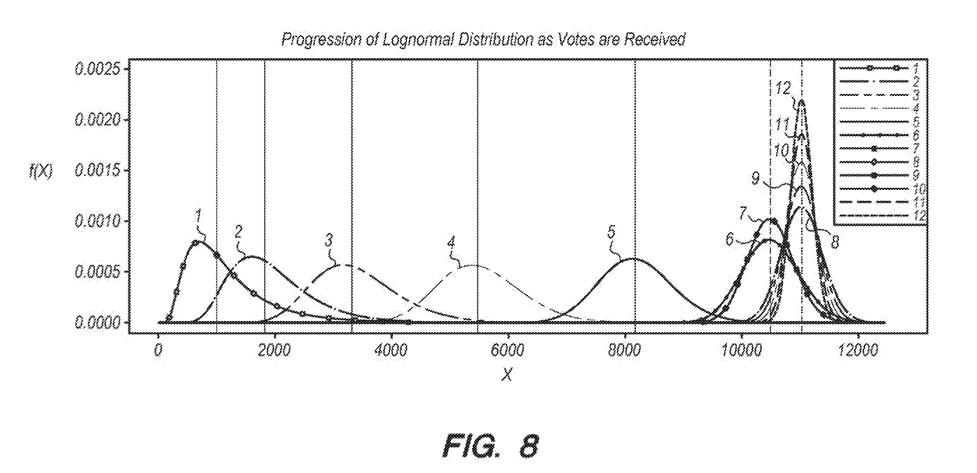

FIG. 8 illustrates an example progression of a log-normal distribution as votes are received. Line 1 is the initial probability distribution for a variable, lines 2-11 are immediate distributions, and line 12 is the final probability distribution. The figure shows how the underlying distribution can shift and shrink according to received votes. First, the mean is increased, and, therefore, the distribution shifts to the right. Then the variance shrinks, and the distribution gets tighter and hones in on the crowd's estimate.

The methods described herein are embodied in software and performed by a computer system (comprising one or more computing devices) executing the software. A person skilled in the art would understand that a computer system has one or more memory units, disks, or other physical, computer-readable storage media for storing software instructions, as well as one or more processors for executing the software instructions.

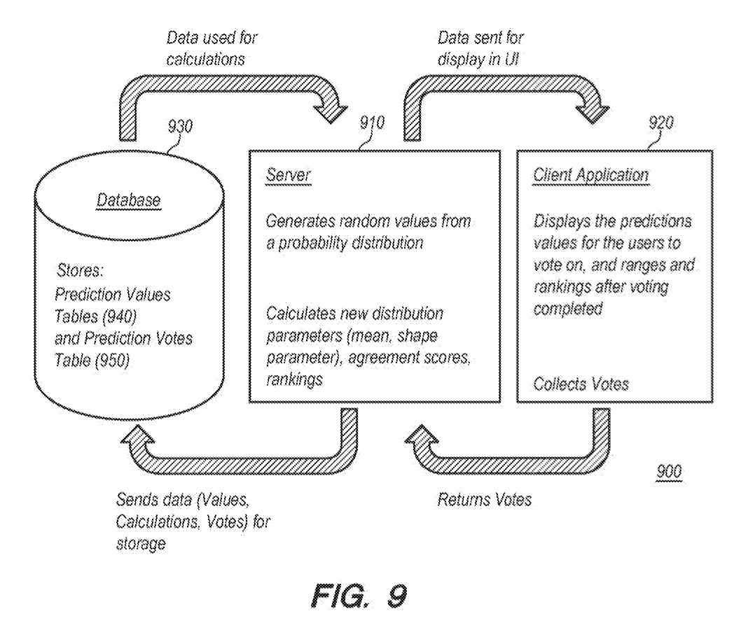

FIG. 9 illustrates an example idea management system 900. The system 900 includes one or more servers 910, client applications 920 on client devices, and one or more databases 930. Server 910 runs software (e.g., Java) that enables the server to create the probability distributions and calculate the rankings, as described above. The client application 920 displays the user interfaces described above (e.g., polling pages, ranking pages, etc.). The client application 920 may be a web-browser client, or may be a stand-alone desktop or mobile software application.

In one embodiment, the database 930 includes a Predictions Values Table 940 and a Predictions Votes Table 950. Each idea and question voted on (each question is associated with a variable) is associated with a unique ID. The Prediction Votes Table 950 stores the IDs for each idea and question voted on, and, for each idea/question pair, the value that is displayed to each user for that question/idea, and whether the user voted up or down. The Predictions Values Tables 940 stores the idea and question IDs, the current values for the probability distribution (mean, variance), and the agreement score for each idea/question combination.

In one embodiment, the client application 920 requests from the server 910 an idea to vote on when the user visits a voting page/screen in the client application 920. In response to receiving the request, the server 910 picks an idea in the system (i.e., from database 930). The server may select the idea randomly or by prioritizing ideas for which votes are needed. For each variable in the idea (e.g., cost, time, and revenue/savings), the server 910 then generates a random sample from the most recent probability distribution curve for the variable, wherein the server obtains the probability distribution data from database 930. The server 910 sends the idea and values to the client application 920, and the client application 920 displays the page/screen with the up/down vote options for the idea (e.g., see FIG. 4). In response to the user voting on the idea, the client application 920 sends the vote data back to the server 910, which, as described above, creates a new probability distribution curve for each of the variables on which the user voted. The vote data and distribution curve parameters are stored in database 930. The process repeats if a user moves onto a next item on which to vote on the voting page. Users can view leaderboards with rankings (e.g., FIG. 7) in the client application 920. In one embodiment, a user must complete voting for all ideas in order to see the leaderboards.

As will be understood by those familiar with the art, the invention may be embodied in other specific forms without departing from the spirit or essential characteristics thereof. Accordingly, the above disclosure is intended to be illustrative, but not limiting, of the scope of the invention, which is set forth in the following claims.

1. A method, performed by a computer system, for predicting the value of an idea entered into an idea-management platform, the method comprising:
(a) creating a probability distribution for values for each of: (i) a cost to implement an idea, (ii) a time to implement the idea, and (iii) a revenue/savings associated with the idea, wherein each probability distribution initially has a mean value and shape parameter that are predetermined;
(b) polling a plurality of users as to cost, time, and revenue/saving values for the idea, wherein polling a user comprises displaying a proposed value for a cost, time, or revenue/savings variable for the idea and enabling the user to vote whether the user's estimate for the variable is greater than or less than the proposed value, and wherein the proposed values for the variables displayed to users are derived from the respective probability distributions for the variables;
(c) in response to receiving a vote for a value of one of the variables, creating a new probability distribution for the variable, including calculating a new mean and a new shape parameter for the probability distribution based on votes received for the variable, wherein calculating a new mean comprises calculating a consensus value for the variable that reflects vote(s) received for the variable and using the consensus value as the new mean and displaying a revised proposed value based on the new probability distribution;
(d) repeating steps (b) and (c) for each of the variables until a polling-termination event occurs, wherein, in repeating step (b) for a variable, the value displayed for the variable is derived from the new probability distribution created in the previous step (c) for the variable; and
(e) in response to the occurrence of a polling-termination event occurring, calculating a ranking for the idea based on the last-calculated consensus values for the cost, time, and revenue/saving variables; and
(f) displaying a ranked list of ideas in a user interface based on calculated rankings for the ideas, including displaying the last-calculated consensus values for the cost, time, and revenue/saving variables for each of the ideas.

2. The method of claim 1, wherein calculating the new shape parameter comprises:
calculating an agreement score that reflects a degree to which users agree on the consensus value for the variable;
calculating a standard deviation of votes that disagree with the consensus value; and
calculating a new shape parameter for the probability distribution as a function of the agreement score and the standard deviation of votes that disagree with the consensus value.

3. The method of claim 2, wherein the agreement score is based on a ratio of (i) the number of votes pointing towards the consensus value to (ii) the total number of votes received for the variable.

4. The method of claim 3, wherein the ranking is a metric of (Revenue-Cost)/Time, using the last-calculated consensus values for the revenue/saving, cost, and time variables and factoring in the agreement scores for the revenue/saving, cost, and time variables.

5. The method of claim 1, wherein the consensus value in step (c) is calculated using a weighted average of up and down votes.

6. The method of claim 1, wherein the probability distribution is a log-normal distribution.

7. The method of claim 1, wherein the poll termination event is the expiration of a time limit for the polling.

8. The method of claim 1, wherein the poll termination event is the receipt of a minimum number of votes for each of the variables.

9. A non-transitory, computer-readable medium comprising a computer program, that, when executed by a computer system, enables the computer system to perform the following method for predicting the value of an idea entered into an idea-management platform, the method comprising:
(a) creating a probability distribution for values for each of: (i) a cost to implement an idea, (ii) a time to implement the idea, and (iii) a revenue/savings associated with the idea, wherein each probability distribution initially has a mean value and shape parameter that are predetermined;
(b) polling a plurality of users as to cost, time, and revenue/saving values for the idea, wherein polling a user comprises displaying a proposed value for a cost, time, or revenue/savings variable for the idea and enabling the user to vote whether the user's estimate for the variable is greater than or less than the proposed value, and wherein the proposed values for the variables displayed to users are derived from the respective probability distributions for the variables;
(c) in response to receiving a vote for a value of one of the variables, creating a new probability distribution for the variable, including calculating a new mean and a new shape parameter for the probability distribution based on votes received for the variable, wherein calculating a new mean comprises calculating a consensus value for the variable that reflects vote(s) received for the variable and using the consensus value as the new mean and displaying a revised proposed value based on the new probability distribution;
(d) repeating steps (b) and (c) for each of the variables until a polling-termination event occurs, wherein, in repeating step (b) for a variable, the value displayed for the variable is derived from the new probability distribution created in the previous step (c) for the variable; and
(e) in response to the occurrence of a polling-termination event occurring, calculating a ranking for the idea based on the last-calculated consensus values for the cost, time, and revenue/saving variables; and
(f) displaying a ranked list of ideas in a user interface based on calculated rankings for the ideas, including displaying the last-calculated consensus values for the cost, time, and revenue/saving variables for each of the ideas.

10. The non-transitory, computer-readable medium of claim 9, wherein calculating the new shape parameter comprises:
calculating an agreement score that reflects a degree to which users agree on the consensus value for the variable;
calculating a standard deviation of votes that disagree with the consensus value; and
calculating a new shape parameter for the probability distribution as a function of the agreement score and the standard deviation of votes that disagree with the consensus value.

11. The non-transitory, computer-readable medium of claim 10, wherein the agreement score is based on a ratio of (i) the number of votes pointing towards the consensus value to (ii) the total number of votes received for the variable.

12. The non-transitory, computer-readable medium of claim 11, wherein the ranking is a metric of (Revenue-Cost)/Time, using the last-calculated consensus values for the revenue/saving, cost, and time variables and factoring in the agreement scores for the revenue/saving, cost, and time variables.

13. The non-transitory, computer-readable medium of claim 9, wherein the consensus value in step (c) is calculated using a weighted average of up and down votes.

14. The non-transitory, computer-readable medium of claim 9, wherein the probability distribution is a log-normal distribution.

15. The non-transitory, computer-readable medium of claim 9, wherein the poll termination event is the expiration of a time limit for the polling.

16. The non-transitory, computer-readable medium of claim 9, wherein the poll termination event is the receipt of a minimum number of votes for each of the variables.

17. A system for predicting the value of an idea entered into an idea-management platform, the system comprising:
one or more processors;
one or more memory units coupled to the one or more processors, wherein the one or more memory units store instructions that, when executed by the one or more processors, cause the system to perform the operations of:
(a) creating a probability distribution for values for each of: (i) a cost to implement an idea, (ii) a time to implement the idea, and (iii) a revenue/savings associated with the idea, wherein each probability distribution initially has a mean value and shape parameter that are predetermined;
(b) polling a plurality of users as to cost, time, and revenue/saving values for the idea, wherein polling a user comprises displaying a proposed value for a cost, time, or revenue/savings variable for the idea and enabling the user to vote whether the user's estimate for the variable is greater than or less than the proposed value, and wherein the proposed values for the variables displayed to users are derived from the respective probability distributions for the variables;
(c) in response to receiving a vote for a value of one of the variables, creating a new probability distribution for the variable, including calculating a new mean and a new shape parameter for the probability distribution based on votes received for the variable, wherein calculating a new mean comprises calculating a consensus value for the variable that reflects vote(s) received for the variable and using the consensus value as the new mean and displaying a revised proposed value based on the new probability distribution;
(d) repeating steps (b) and (c) for each of the variables until a polling-termination event occurs, wherein, in repeating step (b) for a variable, the value displayed for the variable is derived from the new probability distribution created in the previous step (c) for the variable; and
(e) in response to the occurrence of a polling-termination event occurring, calculating a ranking for the idea based on the last-calculated consensus values for the cost, time, and revenue/saving variables; and
(f) displaying a ranked list of ideas in a user interface based on calculated rankings for the ideas, including displaying the last-calculated consensus values for the cost, time, and revenue/saving variables for each of the ideas.

18. The system of claim 17, wherein calculating the new shape parameter comprises:
calculating an agreement score that reflects a degree to which users agree on the consensus value for the variable;
calculating a standard deviation of votes that disagree with the consensus value; and
calculating a new shape parameter for the probability distribution as a function of the agreement score and the standard deviation of votes that disagree with the consensus value.

19. The system of claim 18, wherein the agreement score is based on a ratio of (i) the number of votes pointing towards the consensus value to (ii) the total number of votes received for the variable.

20. The system of claim 19, wherein the ranking is a metric of (Revenue-Cost)/Time, using the last-calculated consensus values for the revenue/saving, cost, and time variables and factoring in the agreement scores for the revenue/saving, cost, and time variables.

21-24. (canceled)
